(19) United States
(12) Patent Application Publication
(10) Pub. No.: US 2012/0005616 A1
(43) Pub. Date: Jan. 5, 2012

(54) METHODS AND SYSTEMS FOR PROVIDING INFORMATION ABOUT A NARRATIVE

(75) Inventors: Richard J. Walsh, Raleigh, NC (US); Michael W. Helpingstine, Chapel Hill, NC (US); Netant Misra, Raleigh, NC (US)

(73) Assignee: Oto Technologies, LLC, Raleigh, NC (US)

(21) Appl. No.: 13/033,078

(22) Filed: Feb. 23, 2011

Related U.S. Application Data
(63) Continuation of application No. 12/826,777, filed on Jun. 30, 2010, now abandoned.

(51) Int. Cl. G06F 3/048

(52) U.S. Cl. 715/776

(57) ABSTRACT

A method and system for providing information about a novel. A portion of the novel is displayed on a display. Selections of a first term at a first location and a second term at a second location are received. A current location within the novel is determined. A plurality of relationships between the first term and the second term that have been referred to in the novel prior to the current location is determined, and information about the plurality of relationships is displayed.

### CROSS-REFERENCE TO RELATED APPLICATION

This application claims priority to and is a continuation of co-pending U.S. patent application Ser. No. 12/826,777, entitled “METHODS AND SYSTEMS FOR PROVIDING INFORMATION ABOUT A NARRATIVE,” which was filed on Jun. 30, 2010, and the disclosure of which is hereby incorporated herein by reference in its entirety.

### FIELD OF THE DISCLOSURE

Embodiments of the disclosure relate to electronic readers, and in particular to providing information relating to a narrative in response to user input.

### BACKGROUND

An electronic reader (e-reader) visually presents a narrative, such as those contained in magazines, newspapers, or books, on a display. E-readers are increasingly popular with consumers. The presentation of a narrative in an electronic format allows a reader to do things that cannot be done in a conventional paper-based format, such as finding words in the narrative easily and quickly, adjusting the text size or font of the narrative based on personal preferences, and setting the contrast or brightness of a display to an appropriate level based on ambient lighting conditions.

Despite the advantages of an e-reader, a reader may frequently encounter certain frustrations with a narrative, whether the narrative is in a paper or electronic form. For example, when reading a long narrative, such as a novel, it is often difficult for a reader to recall relevant facts about the narrative between readings, such as the relationship between two characters, or even who a particular character is. It may even be necessary for the reader to reread portions of the narrative. This can be time-consuming, and may also be frustrating, especially where it is not obvious which portions of the narrative contain the desired information. There is a need, therefore, for a mechanism that allows a reader to easily and intuitively obtain information about identified aspects of the narrative, without providing information that occurs in subsequent portions of the narrative that the reader has not yet read.

Frequently, a reader would like a summary of a narrative. This may be desired to determine whether the reader has an interest in the narrative, or to determine whether the reader has already read the narrative. It is difficult to flip through pages of a narrative and visually detect only those words that provide information useful in ascertaining the general topic of a narrative. There is a need, therefore, for a mechanism that allows a reader to easily and intuitively obtain a summary of a narrative, at a selectable level of detail desired by a reader.

### SUMMARY

Embodiments of the present disclosure relate to methods and apparatus that provide a reader of a narrative information about the narrative in response to user input. In one embodiment, an electronic reader (e-reader) displays a portion of a narrative, such as a page of a book, on a display device. A user selects first and second terms at respective first and second locations in the displayed portion of the narrative. The e-reader accesses a narrative structure that contains narrative entries that identify relationships between terms in the narrative. The e-reader determines a current location within the narrative, and identifies those narrative entries that identify a relationship between the first term and the second term, and which have been referred to in the narrative prior to the current location. The e-reader displays information describing the relationships to the user. Thus, the user can easily and intuitively obtain important information about characters, places, and other things referred to in the narrative that the user may have forgotten, or not completely understood, without having to locate and reread portions of the narrative.

A narrative entry may identify a subject; an object; and a predicate that identifies a relationship between the subject and the object. The narrative entry may also include information such as a location in the narrative where the relationship is first discussed, and a location in the narrative where the relationship is no longer accurate. The narrative entry may also include a description field containing a textual description of the relationship, and multimedia content such as video, audio or an image. By searching narrative entries based on subjects or objects, the e-reader can quickly identify relationships between multiple selected terms in the narrative.

In one embodiment, the user may highlight a portion of the text of the narrative. In response, the e-reader determines which words in the highlighted portion of text are terms contained in the narrative structure, and visually distinguishes those terms on the display for the user. The user may then select one or more of the terms as the first term and the second term.

The current location may be determined by the one of the first location and the second location that is closest to the end of the narrative. Alternately, the user may designate a third location as the current location. In another embodiment, the current location is based on the portion of the narrative that is displayed on the display at the time of selection of the first term.

In another embodiment, the e-reader provides summary information to a user. The e-reader displays a portion of a narrative in the display, and receives from the user input indicating a desire for summary information. The e-reader determines a desired summary level from a plurality of summary levels. The narrative entries in the narrative structure include corresponding level identifiers, and the e-reader selects a plurality of the narrative entries based on the desired summary level and the corresponding level identifiers. The e-reader displays information on the display based on the plurality of narrative entries.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a block diagram of a system in which embodiments disclosed herein may be practiced;

FIG. 2 is a message flow diagram illustrating message flow and associated processing for providing information to a user about a narrative according to one embodiment;

FIG. 3 illustrates an exemplary user interface according to one embodiment;

FIG. 4 illustrates the exemplary user interface shown in FIG. 3 at a subsequent location in the narrative;

FIG. 5 illustrates an exemplary representation of a narrative structure according to one embodiment;

FIG. 6 illustrates a narrative structure according to one embodiment;

FIG. 7 illustrates an exemplary embodiment wherein a user may request that the e-reader identify terms that have corresponding relationships identified in the narrative structure;

FIG. 8 illustrates a user interface of a narrative structure generation tool according to one embodiment;

FIG. 9 illustrates a user interface for presenting summary information according to another embodiment;

FIG. 10 is a message flow diagram illustrating a message flow and associated processing by the e-reader to provide summary information to a user;

FIG. 11 illustrates an exemplary portion of a summary narrative structure containing summary information; and

FIG. 12 illustrates an exemplary computing device that may be used to implement an e-reader according to one embodiment.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

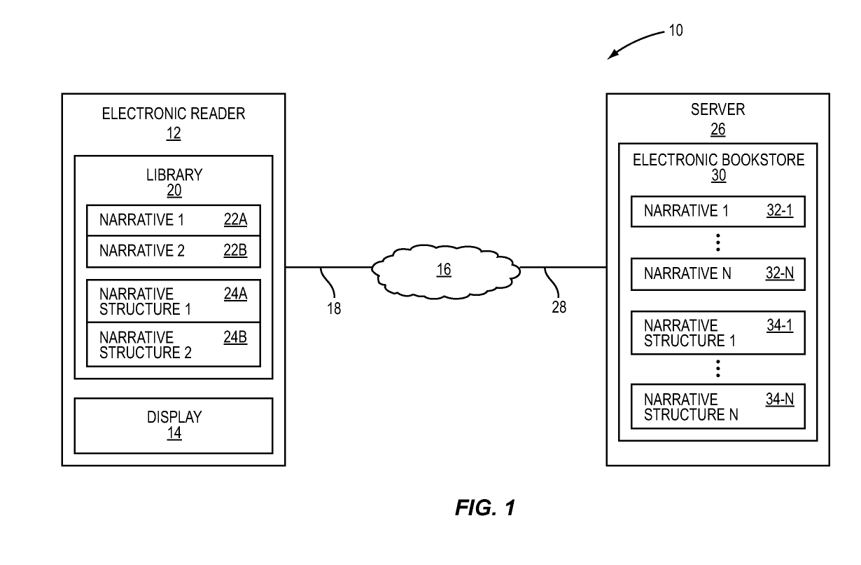

FIG. 1 is a block diagram of a system 10 in which embodiments disclosed herein may be practiced. The system 10 includes an electronic reader (e-reader) 12 that is capable of presenting a narrative, such as those contained in magazines, newspapers, books, and the like, to a user via a display 14. The e-reader 12 may comprise any computing device capable of implementing the functionality described herein, including, for example, a laptop computer, a cellular phone, a personal digital assistant (PDA), an Apple® iPad™, an Amazon® Kindle™, a Barnes & Noble® Nook™ and the like. The e-reader 12 may be capable of interfacing with a network 16 via a communications link 18, such as a Wi-Fi® link, cellular link, Bluetooth® link, or the like. Alternately, the e-reader 12 may access the network 16 indirectly via another computing device, such as a personal computer, to which the e-reader 12 may be coupled via a USB connection or the like.

The e-reader 12 includes an electronic library 20. The library 20 stores a plurality of narratives 22A, 22B (generally, narrative 22 or narratives 22). The narrative 22 may comprise any type of reading material, such as a book, a magazine, a newspaper, or the like. Preferably, the narratives 22A, 22B have corresponding narrative structures 24A, 24B (generally, narrative structure 24 or narrative structures 24), respectively, which, as discussed in greater detail herein, contain semantic content elements that, among other information, identify relationships between terms in the corresponding narrative 22. A “term,” as used herein, refers to a single or multi-word phrase in a narrative 22 that has a respective semantic content element in a corresponding narrative structure 24. A term can be a person, place, or any other entity in the narrative 22 capable of having a relationship with another entity. The word “relationship” refers to the association between two terms in the narrative 22. For example, the association between characters Joe and Bob may be that Joe is a friend of Bob's. The relationship between Joe and Las Vegas may be that Joe was born in Las Vegas. There may be multiple associations between two terms. For example, Joe may also have gotten divorced in Las Vegas.

The system 10 also includes a server 26 that is coupled to the network 16 via a communications link 28. The server 26 includes an electronic bookstore 30 which offers a number of narratives 32-1-32-N for purchase or lease, as well as corresponding narrative structures 34-1-34-N.

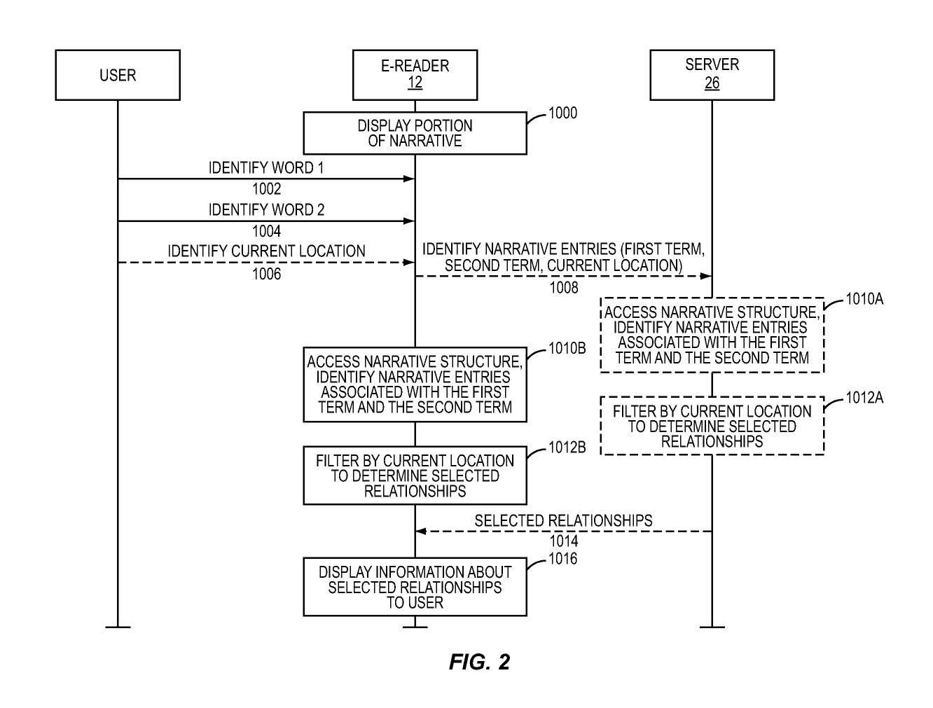

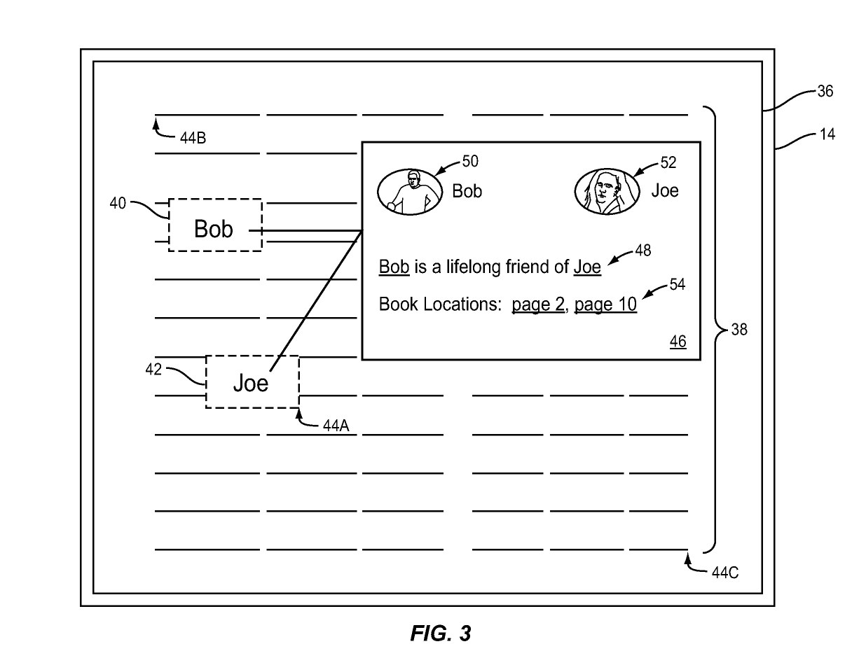

FIG. 2 is a message flow diagram for providing information to the user about a narrative 22 according to one embodiment. FIG. 3 illustrates an exemplary user interface 36 according to one embodiment. FIG. 2 will be discussed in conjunction with FIGS. 1 and 3. Initially, the e-reader 12 may display a portion 38 in the user interface 36 (FIG. 2, step 1000). The portion 38 may comprise a cover of the narrative 22, inner or outer flaps, or portions of the text of the narrative 22, for example. The portion 38 may be provided in conjunction with images, such as the edges of multiple pages, which make the portion 38 appear to be part of a physical book, for example.

The user selects a first term 40 (FIG. 2, step 1002). The user may select the first term 40 using an input device such as a mouse, keyboard, or keypad, or by using a finger if the display 14 includes touch-sensing capabilities. The user also selects a second term 42 (FIG. 2, step 1004). In one embodiment, the e-reader 12 determines a first location in the narrative 22 corresponding to the first term 40 and a second location in the narrative 22 corresponding to the second term 42. Locations within the narrative 22 may be quantified in any desired manner, such as by a word offset of a selected term from the beginning of the narrative, or by a page, a sentence, and the word offset of the selected term from the beginning of the sentence, for example.

The e-reader 12 also determines a current location, which is used to determine which relationships should be described to the user, and which should not. The current location can be determined, for example, by using the one of the first location and the second location that is nearest the end of the narrative. For example, the e-reader 12 may determine the current location to be a location 44A if the second location of the second term 42 is nearer the end of the narrative 22 than the first location of the first term 40. Alternately, the user may designate a current location (FIG. 2, step 1006). For example, the user may designate a location 44B that is prior to either the first location or the second location, or may designate a location subsequent to the first location or the second location. The user may designate the location 44B using, for example, an input device such as a mouse, a keyboard, via touch if the display is touch-capable, of via gazing at the location 44B if the e-reader 12 includes gaze detection technology. In another embodiment, the e-reader may determine the current location based on the displayed portion 38. For example, the e-reader may determine that the current location is the location 44C, which is the location of the last displayed word of the portion 38.

In one embodiment, the narrative structure 24 resides on a computing device other than the e-reader 12, such as on the server 26. In such embodiment, the e-reader 12 sends a message including the first term 40, the second term 42, and the current location 44, and requests that the server 26 identify narrative entries associated with the first term 40 and the second term 42 (FIG. 2, step 1008). In response thereto, the server 26 accesses the narrative structure 24 to identify narrative entries associated with the first term 40 and the second term 42 (FIG. 2, step 1010A). In another embodiment, the narrative structure 24 may be stored on the e-reader 12, in which event the e-reader 12 accesses the narrative structure 24 to identify narrative entries associated with the first term 40 and the second term 42 (FIG. 2, step 1010B).

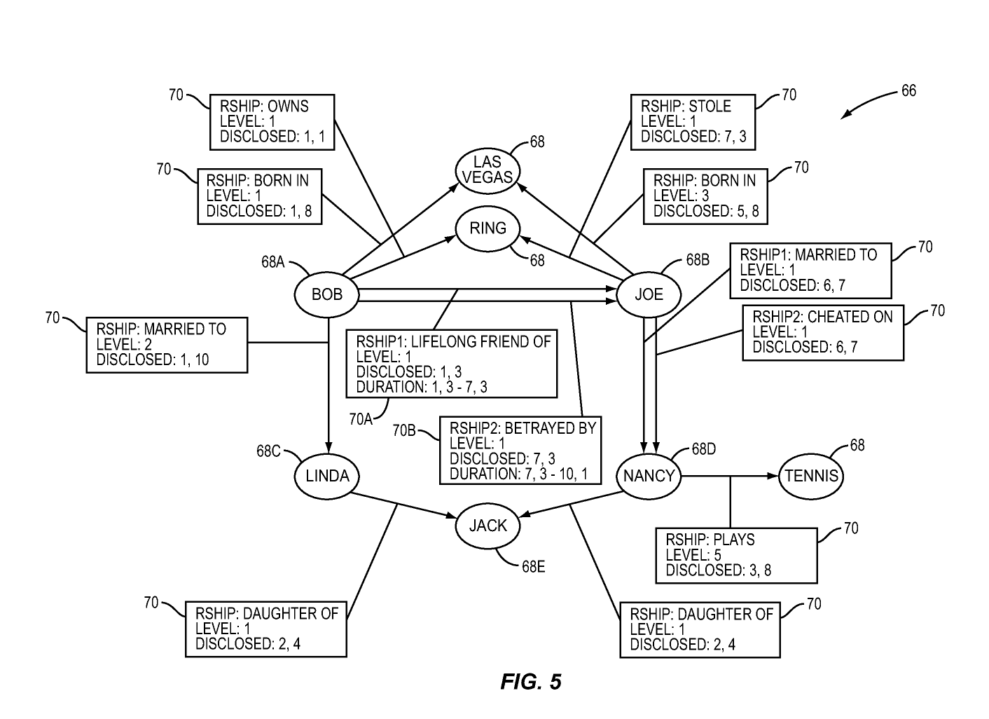

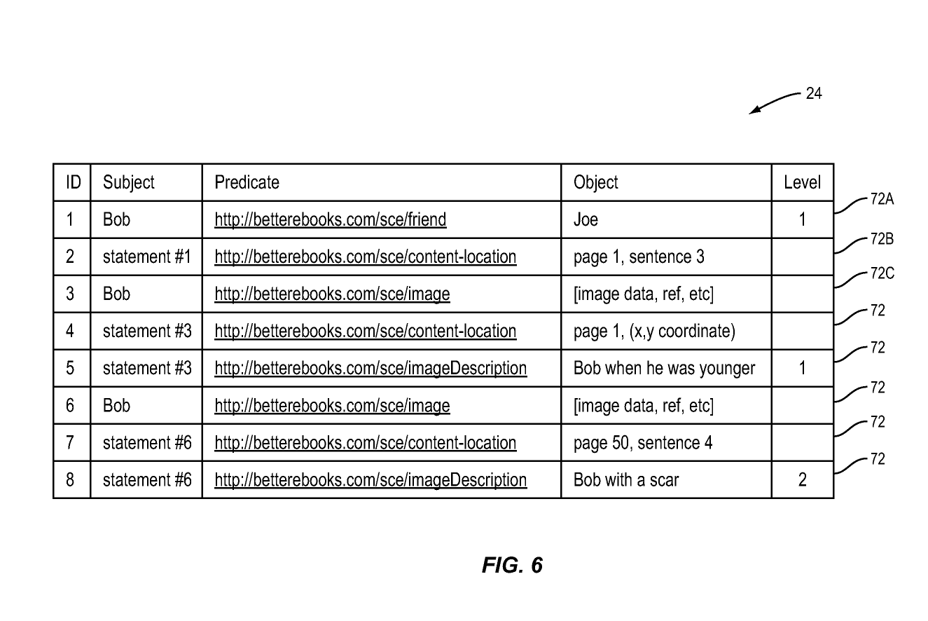

As will be discussed in greater detail herein with regard to FIGS. 5 and 6, the narrative entries are semantic content elements that identify relationships between terms in the narrative 22. The semantic content elements may be in any suitable format or structure, as long as the terms and the relationships may be identified and described to the user.

The identified narrative entries are filtered based on the current location to determine selected relationships (FIG. 2, steps 1012A, 1012B). This is to prevent relationships identified in narrative entries that are referred to in the narrative 22 at a location after the current location from being disclosed to the user. If the user desires that narrative entries subsequent to the user's current location be disclosed, the user may select a current location that is subsequent to their location in the narrative that the user is currently reading. Alternately, the use of a current location may be optional. If the server 26 has determined the selected relationships, the server 26 provides the selected relationships to the e-reader 12 (FIG. 2, step 1014). The e-reader 12 displays information describing the selected relationships to the user (FIG. 2, step 1016).

Referring to FIG. 3, the information describing the selected relationships may be displayed in a window 46, and may include, for example, text 48 that includes the information describing the selected relationship (in this example, that Bob is a lifelong friend of Joe). The window 46 may also include images 50 and 52 corresponding to Bob and Joe, respectively. The images 50, 52 may have, for example, been illustrated at points in the narrative 22 prior to the current location. The window 46 may also include text 54 identifying one or more locations in the narrative 22 where the relationship is discussed. Although only information about a single relationship is illustrated in FIG. 3, it is apparent that there may be multiple relationships between Bob and Joe, and all such relationships referred to in the narrative 22 prior to the current location may be presented in the window 46. Moreover, while embodiments are disclosed herein with reference to relationships between two terms, the embodiments disclosed herein are equally applicable to any number of terms.

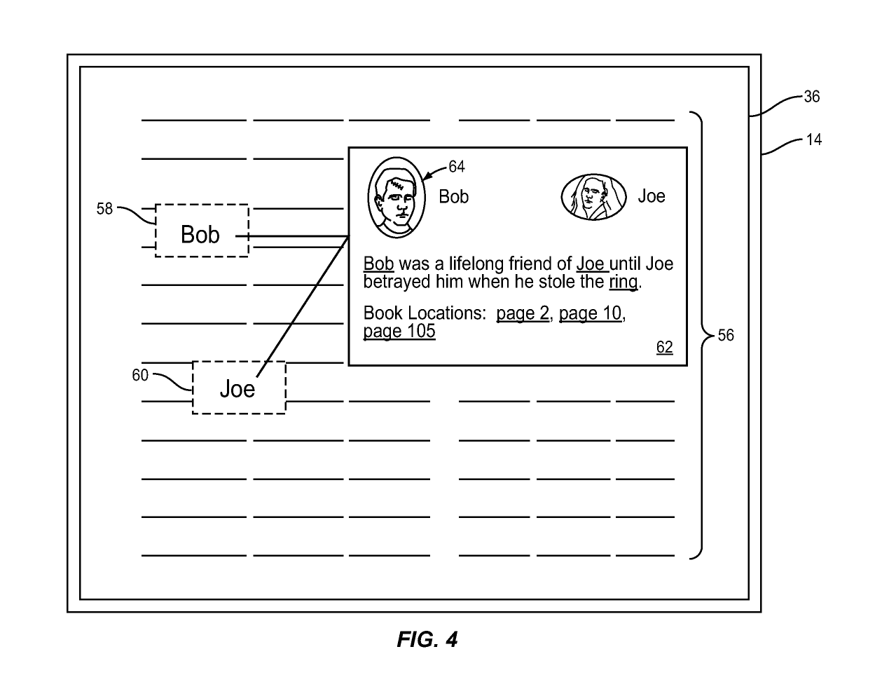

FIG. 4 illustrates the exemplary user interface 36 at a subsequent location in the narrative 22. A portion 56 of the narrative 22 is displayed on the display 14. Assume that the user identifies a first term 58 and a second term 60 in the portion 56. Also assume the first term 58 is the same term as the first term 40 (FIG. 3), and that the second term 60 is the same term as the second term 42 (FIG. 3), but that the current location is at a subsequent location in the narrative 22. Also assume that the character Bob, identified by the first term 58, had been injured in between the portion 38 illustrated in FIG. 3 and the portion 56, and that Joe, identified by the second term 60, had betrayed Bob by stealing Bob's ring. Thus, when accessing the narrative structure 24, the e-reader 12 now selects additional relationships, based on the new current location, that identify the betrayal of Bob by Joe, and the stealing of Bob's ring by Joe. The information describing these relationships is displayed in a window 62. Notably, an image 64 now illustrates Bob's injury.

Embodiments, as described herein, enable a user to relatively easily and intuitively obtain information about relationships between terms in a narrative, eliminating a need to locate and reread portions of the narrative that discuss the terms and relationships.

FIG. 5 illustrates an exemplary representation of a narrative structure 24 according to one embodiment. The representation is a graph 66 wherein nodes 68 of the graph represent terms, and connections 70 between nodes represent relationships. The graph 66 may be stored in a graph format, wherein the terms are stored as nodes and the relationships between nodes are stored as connections, or may be generated internally by software from another type of structure, such as a table structure identifying terms and relationships between terms. Each connection 70 and the two nodes 68 connected by the connection 70 may be considered a narrative entry.

The graph 66 illustrates that a node 68A represents the term “Bob” and a node 68B represents the term “Joe.” A connection 70A identifies a relationship between Bob and Joe that indicates that Bob is a lifelong friend of Joe. The connection 70A may also indicate that this relationship is first disclosed at page 1, sentence 3 of the narrative 22, and is true up until page 7, sentence 3 of the narrative. A connection 70B identifies a second relationship between Bob and Joe that indicates that Bob is betrayed by Joe at page 7, sentence 3. In one embodiment, the e-reader 12 may traverse multiple connections 70 to determine relationships between nodes 68. A number of connections 70 which may be traversed may be user selectable or otherwise configurable. For example, assume that the user indicates that he is interested in relationships between two terms within two connections of one another, and selects “Bob” as the first term, and “Joe” as the second term. The e-reader 12 identifies the node 68A as representing the term “Bob” and the node 68B as representing the term “Joe.” The e-reader 12 determines that the connections 70A and 70B identify a direct relationship between Bob and Joe. Using graphing traversal techniques, the e-reader 12 also determines that a node 68E is within two connections of both the node 68A and the node 68B. The e-reader 12 thus identifies the relationship that Jack is the father of Bob's wife, Linda, and the father of Joe's wife, Nancy.

FIG. 6 illustrates a narrative structure 24 according to one embodiment. The narrative structure 24 is described in a Resource Description Framework (RDF) format. RDF is one of many different formats in which semantic content elements may be defined for use in embodiments disclosed herein. RDF describes relationships using a concept referred to as a “triple.” A triple includes a subject, an object, and a predicate. The predicate describes the relationship between the subject and the object. The narrative structure 24 includes a plurality of narrative entries 72, each of which comprises an RDF triple. The narrative structure 24 may be used, if desired, to generate a graph of nodes and connections, such as that illustrated by the graph 66 in FIG. 5. Each narrative entry 72 either establishes a relationship between two terms, or further identifies characteristics of a relationship between two terms. For example, the narrative entry 72A identifies that Bob is a friend of Joe. The narrative entry 72B indicates that the friend relationship between Bob and Joe is referred to at page 1, sentence 3 of the narrative 22. The narrative entry 72B is an example of reification in RDF, where a “triple” contains information about another “triple.” RDF enables the generation of a narrative structure 24 that can describe in simple, yet searchable and otherwise accessible means, relationships between terms in the narrative 22.

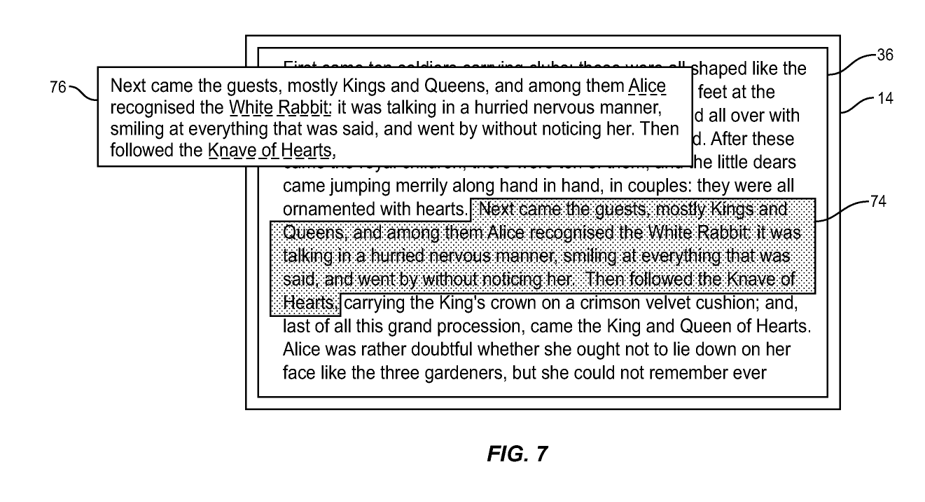

FIG. 7 illustrates an exemplary embodiment wherein a user may request that the e-reader 12 identify terms that have corresponding relationships identified in the narrative structure 24. Assume that the user has highlighted a portion of the narrative 22, indicated by the highlighted portion 74. The user may have highlighted the portion 74 via an input device such as a mouse, for example, or via any other suitable mechanism. Highlighting a portion 74 of narrative 22 may cause the e-reader 12 to analyze the highlighted portion 74, access the narrative structure 24, and determine which terms in the highlighted portion 74 are terms that are identified in the narrative structure 24 as having a relationship with another term. The e-reader 12 may then display a window 76 containing the highlighted portion 74 where the identified terms are visually distinguished from other terms. For example, the identified terms may have a dashed underline, may be bolded, or may be given any other suitable distinguishing visible characteristic that enables the user to easily determine which terms may be suitable for selection. Alternately, rather than display a separate window 76, the e-reader 12 may simply unhighlight the portion 74 and visually distinguish the terms that are identified in the narrative structure 24 as having relationships with other terms. The user may then easily select first, second, and if desired, additional terms, in order to obtain from the e-reader 12 relationships between such terms.

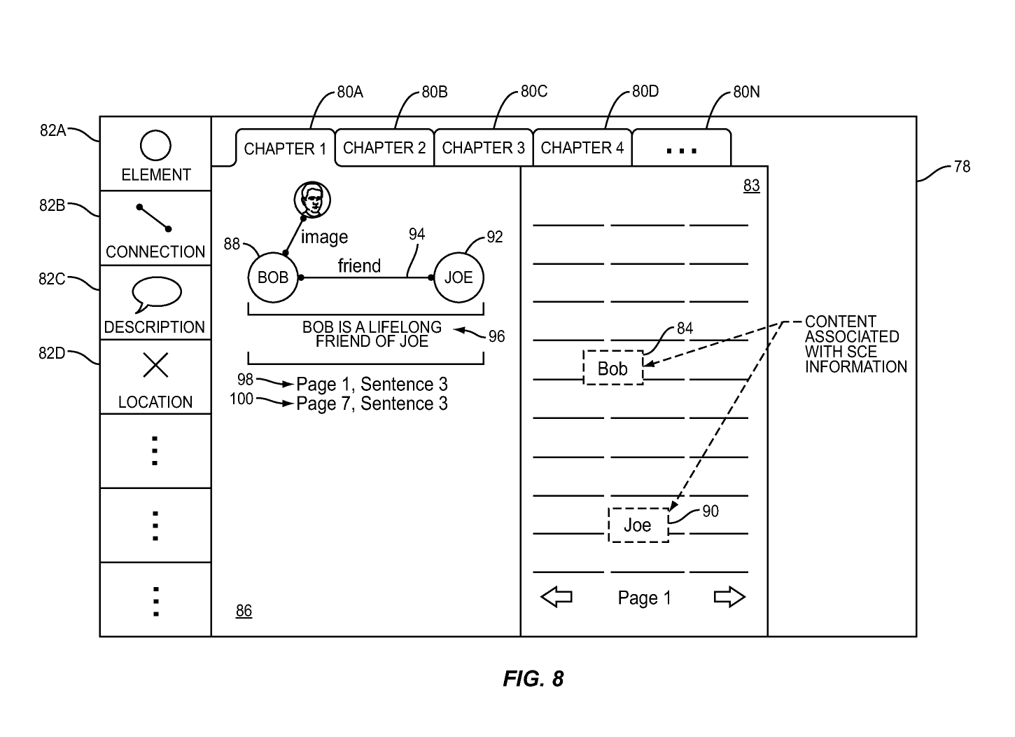

The narrative structure 24 may be in any desired format, such as a relational database format, an XML format, or the like. FIG. 8 illustrates a user interface 78 of a narrative structure generation tool according to one embodiment. A narrative 22 is loaded into the generation tool through a “File Load” or other conventional mechanism. The generation tool parses the narrative 22, identifying chapters of the narrative 22 (where the narrative 22 is a book, for example), and populates the user interface 78 with a plurality of chapter tabs 80A-80N to enable the user to easily select a desired chapter. The user interface 78 includes a plurality of tools 82, including tools 82A-82D, that enable the user to generate semantic content elements which may then be stored as narrative structure entries in one or more desired formats.

A text pane 83 contains an active portion of the narrative 22. Assume that the user desires to establish a semantic content element identifying a relationship between two terms in the narrative 22. In particular, the user desires to indicate that the character Bob is a friend of the character Joe. The user highlights a first term 84 (“Bob”) in the narrative 22, and selects the element tool 82A. This action indicates to the generation tool that the term “Bob” is a term about which a relationship will be identified, and populates a work pane 86 with a representation of the term “Bob” as a node 88. The user then selects a second term 90 (“Joe”) in the narrative 22, and again selects the element tool 82A. The user interface 78 generates a node 92 in the work pane 86 that represents the term “Joe.”

The user selects the connection tool 82B, and draws a connection 94 between the node 88 and the node 92. The connection 94 may have no directional indicator, indicating that the relationship is mutual, or may contain a directional indicator, such as an arrowhead, to indicate that the relationship is one-way. Upon selection of the connection tool 82B, the user may be presented with a list of commonly used connection types, such as mother, father, friend, son, or the like. Alternately, the user may indicate via a keyboard a particular connection type.

Next, the user may select the description tool 82C, which enables the user to enter information 96 about the relationship. This information 96 may be stored in conjunction with the narrative entry and be used by the e-reader 12 to provide a user with information about the relationship between Joe and Bob, for example. The user may select a location tool 82D, and enter both a location 98 within the narrative 22 identifying where this relationship is first discussed, and a duration 100 identifying where this relationship no longer exists. In one embodiment, the generation tool may provide a default location 98 based on the locations of the first term 84 and the second term 90 in the narrative 22.

Using the narrative structure generation tool, the user may identify any number of relationships between any desired terms in the narrative 22. While only two terms are illustrated for purposes of convenience, it should be apparent that the generation of relationships between three or more terms would be handled in a similar fashion. When the user is finished defining the relationships via the narrative structure generation tool, the user may be presented with an option to generate a narrative structure 24 in one or more formats. The generation tool then stores each established relationship between terms as a narrative structure entry in a desired format for subsequent use by the e-reader 12.

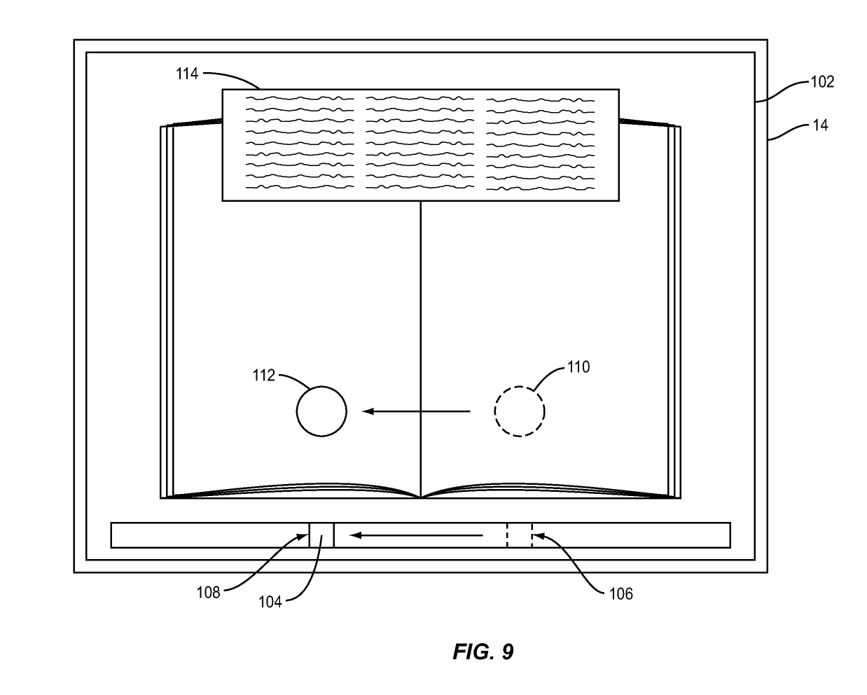

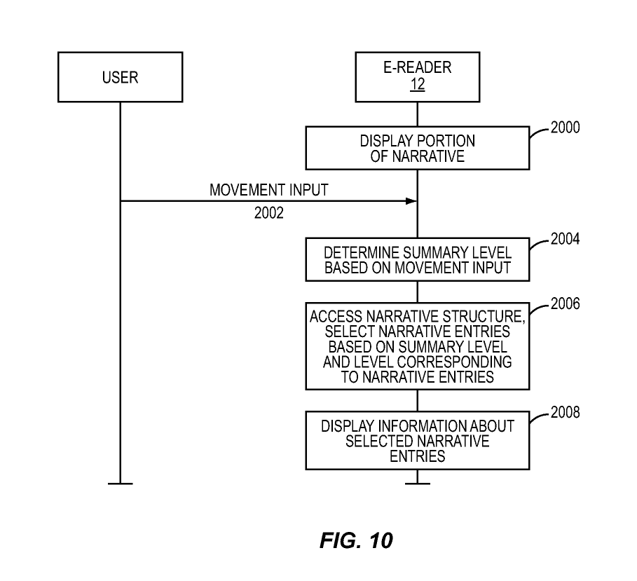

FIG. 9 illustrates a user interface 102 for presenting summary information according to another embodiment. FIG. 10 is a message flow diagram illustrating a message flow and associated processing by the e-reader 12 to provide summary information to the user. FIG. 9 will be discussed in conjunction with FIG. 10. In this embodiment, the user initiates a summary request to obtain summary information about a portion of the narrative 22. For example, the user may have read the first three chapters of the narrative 22 several months earlier, and may not be able to recall the events and characters that were discussed in the first three chapters. The user interface 102 may contain a user selectable option (not illustrated), such as a “SUMMARY” button, that when selected by the user indicates a request for a summary. Alternately, certain actions by the user, such as the rapid movement of a slider bar 104, the movement of a finger across the surface of the display 14, or an audio command, may be used by the e-reader 12 to imply a summary request.

Assume initially that a portion of the narrative 22 is displayed in the user interface 102 (FIG. 10, step 2000). The e-reader 12 determines the portion of the narrative 22 that is currently displayed in the user interface 102. For example, if the cover of the book is displayed in the user interface 102 at the time of the summary request, the e-reader 12 may assume that the reader wants a summary starting at the beginning of the narrative 22, and continuing for as long as the user indicates. The e-reader 12 determines a desired summary level of a plurality of summary levels. The desired summary level, for example, may be selectable by the user, and may be quantified in terms of “Highly Detailed,” “Moderately Detailed,” “Less Detailed,” and the like. The user indicates the end location of the summary by moving at a desired pace through the pages of the narrative 22. The user may move through the pages via the use of a user interface component, such as the slider bar 104. For example, the user may move the slider bar 104 from a first position 106 to a second position 108. If the display 14 is a touch-capable device, the user may move through the pages by touching a first portion of the display 14 at a first location 110 and sliding her finger to a second location 112 on the display 14.

In one embodiment, the e-reader 12 may use the velocity of the movement as the basis for determining the desired summary level (FIG. 10, step 2002). In particular, the e-reader 12 may calculate the velocity, or acceleration, of the movement of the slider bar 104 from the first position 106 to the second position 108, or the velocity, or acceleration, of the movement of the user's finger from the first location 110 to the second location 112. A relatively fast velocity may indicate a high-level summary. A relatively slow velocity may indicate a more detailed summary. The e-reader 12 may then set the desired summary level accordingly (FIG. 10, step 2004).

As the user moves through the pages, the user interface 102 may simulate pages of the narrative 22 “flipping” at a rate that corresponds to the determined velocity. The e-reader 12 selects a begin location in the narrative 22 based on the portion of the narrative 22 that was initially displayed at the time of the summary request by the user, and an end location in the narrative 22 based on which page of the narrative 22 is displayed in the user interface 102 at a given instant in time, and accesses the narrative structure 24 to select narrative entries in the narrative structure that have a level that corresponds to the desired summary level. For example, the narrative entries may have level identifiers that indicate the relative importance of the identified relationship to the narrative 22. Less important relationships may, for example, be designated level 5. Critical relationships may be designated level 1, and other relationships may be designated level 2, 3, or 4 based on their respective importance. Assume that the user indicated a desired summary level of 2. The e-reader 12 therefore selects narrative entries that are referred to in the narrative 22 between the begin location and the end location, and that have level identifiers of 1 and 2. The e-reader 12 may present information about the relationships identified by such narrative entries in a summary window 114.

As the user continues to move through the pages, the e-reader 12 may repeat this process, determining a new begin location based on the previous end location, and a new end location based on a current portion of the narrative 22 that is displayed on the e-reader 12 at a given instant in time, and may continually display information about the relationships obtained from the narrative structure in the window 114. If the desired summary level is based on the velocity of the movement by which the user moves through the pages, the e-reader 12 may also continually modify the desired summary level in accordance with any changes in velocity of the movement by the user. For example, if the user moves through the pages of the first two chapters of the narrative 12 at a relatively rapid rate, the e-reader 12 may set the desired summary level to a level 2, and may provide information about relationships that have a level identifier of 1 or 2, for example. Assume that as the beginning of chapter 3 is displayed in the user interface 102, the user begins to move through the pages relatively slowly. In response, the e-reader 12 may change the desired summary level to a level 4, and begin obtaining narrative entries that have level identifiers 1, 2, 3, or 4. Thus, the e-reader 12 begins to select more detailed relationships from the narrative structure 24, and displays information about such relationships in the window 114. This enables a user to intuitively and easily control the level of importance of the relationships that are provided to the user. For example, assume that the user read the first chapter two months earlier, and the second and third chapters one week earlier. The user may want to advance through the first chapter relatively slowly to obtain more detailed information about the relationships in the first chapter that the user has forgotten, but may desire to advance more rapidly through the second and third chapters to obtain information about only the very important relationships disclosed in such chapters, since the user read those chapters relatively recently.

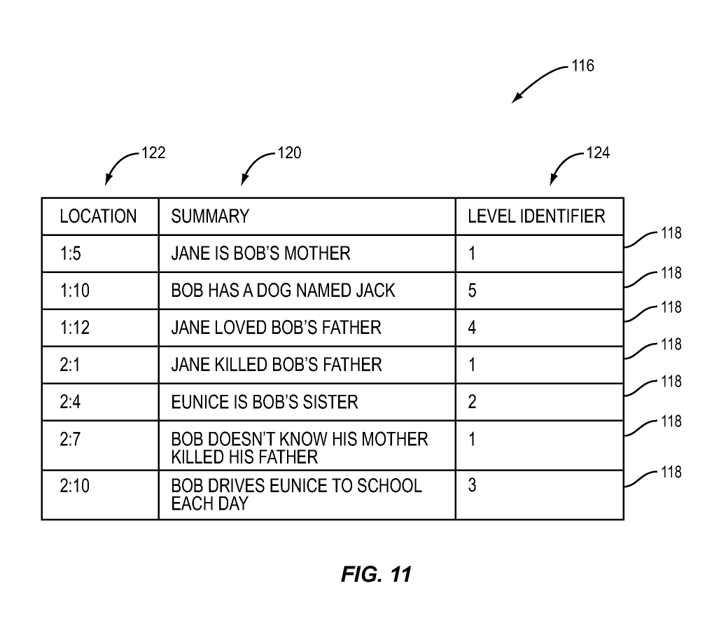

In one embodiment, the e-reader 12 may contain a separate summary narrative structure 116 for providing summary information to the user. FIG. 11 illustrates an exemplary portion of a summary narrative structure 116 containing summary information. The summary narrative structure 116 contains a plurality of summary narrative entries 118. Each summary narrative entry 118 includes a summary field 120 summarizing a relationship in the narrative 22. Each summary narrative entry 118 also includes a location field 122 identifying a location in the narrative 22 where the relationship summarized in the corresponding summary field 120 is first discussed. A level identifier field 124 contains a level identifier indicating a relative importance of the corresponding summary to the narrative 22. When providing summary information to the user, the e-reader 12 may access the summary narrative structure 116 based on the begin location, end location, and desired summary level; rapidly identify appropriate summary narrative entries 118; order the selected summary narrative entries 118 based on the location field 122; and display the corresponding information from the summary field 120 in the summary window 114 as the user moves through the pages of the narrative 22.

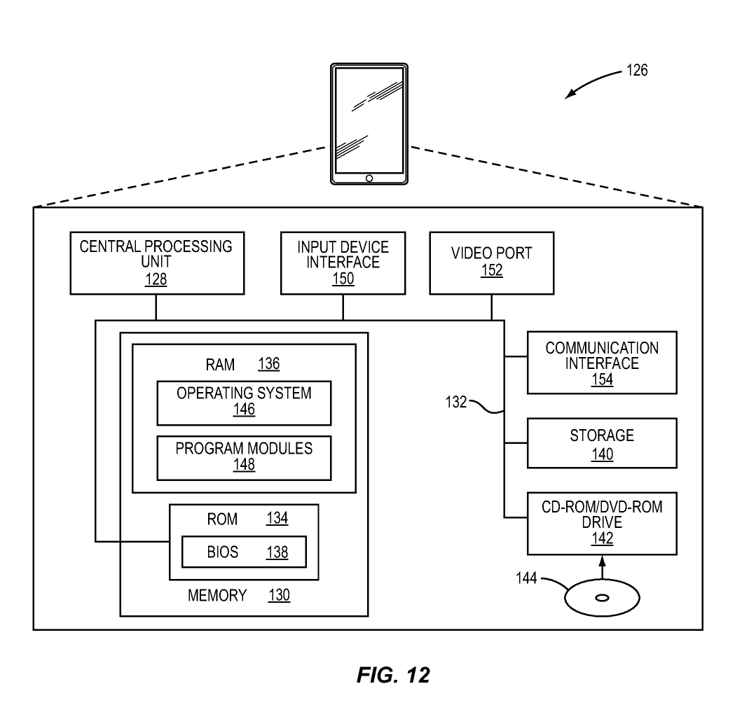

FIG. 12 illustrates an exemplary computing device 126 that may be used to implement an e-reader 12 according to one embodiment. The computing device 126 may, as discussed previously, comprise a laptop computer, a cellular phone, a personal digital assistant (PDA), an Apple® iPad™, an Amazon® Kindle™, a Barnes & Noble® Nook™, or the like. In addition to components discussed previously herein, the exemplary computing device 126 may also include a central processing unit 128, a system memory 130, and a system bus 132. The system bus 132 provides an interface for system components including, but not limited to, the system memory 130 and the central processing unit 128. The central processing unit 128 can be any of various commercially available or proprietary processors. Dual microprocessors and other multi-processor architectures may also be employed as the central processing unit 128.

The system bus 132 can be any of several types of bus structures that may further interconnect to a memory bus (with or without a memory controller), a peripheral bus, and a local bus using any of a variety of commercially available bus architectures. The system memory 130 can include non-volatile memory 134 (e.g., read only memory (ROM), erasable programmable read only memory (EPROM), electrically erasable programmable read only memory (EEPROM), etc.) and/or volatile memory 136 (e.g., random access memory (RAM)). A basic input/output system (BIOS) 138 can be stored in the non-volatile memory 134, and can include the basic routines that help to transfer information between elements within the computing device 126. The volatile memory 136 can also include a high-speed RAM such as static RAM for caching data.

The computing device 126 may further include a storage 140, which may comprise, for example, an internal hard disk drive (HDD) (e.g., enhanced integrated drive electronics (EIDE) or serial advanced technology attachment (SATA)) for storage, for storing one or more narratives 22 and narrative structures 24. The computing device 126 may further include an optical disk drive 142 (e.g., for reading a CD-ROM or DVD-ROM 144). The drives and associated computer-readable media provide non-volatile storage of data, data structures, computer-executable instructions, and so forth. For the computing device 126, the drives and media accommodate the storage of any data in a suitable digital format. Although the description of computer-readable media above refers to an HDD and optical media such as a CD-ROM or DVD-ROM, it should be appreciated by those skilled in the art that other types of media which are readable by a computer, such as Zip disks, magnetic cassettes, flash memory cards, cartridges, and the like, may also be used in the exemplary operating environment, and further, that any such media may contain computer-executable instructions for performing novel methods of the disclosed architecture.

A number of program modules can be stored in the drives and volatile memory 136, including an operating system 146 and one or more program modules 148, which implement the functionality described herein, including, for example, functionality associated with the display of the narrative 22, access of the narrative structure 24, and associated processing and functionality described herein. It is to be appreciated that the embodiments can be implemented with various commercially available operating systems or combinations of operating systems. All or a portion of the embodiments may be implemented as a computer program product, such as a computer-usable or computer-readable medium having a computer-readable program code embodied therein. The computer-readable program code can include software instructions for implementing the functionality of the embodiments described herein. The central processing unit 128, in conjunction with the program modules 148 in the volatile memory 136, may serve as a control system for the computing device 126 that is configured to, or adapted to, implement the functionality described herein.

A user may be able to enter commands and information into the computing device 126 through one or more wired or wireless input devices, for example, a keyboard and a pointing device, such as a mouse (not illustrated), or via the display 14 where the display 14 is a touch screen. Other input devices (not illustrated) may include a microphone, an infrared (IR) remote control, a joystick, a game pad, a stylus pen, or the like. These and other input devices are often connected to the central processing unit 128 through an input device interface 150 that is coupled to the system bus 132 but can be connected by other interfaces, such as a parallel port, an IEEE 1394 serial port, a game port, a universal serial bus (USB) port, an IR interface, etc.

The computing device 126 may drive a separate or integral display device 14, which may also be connected to the system bus 132 via an interface, such as a video port 152. The computing device 126 operates in a networked environment using a wired and/or wireless network communications interface 154. The communications interface 154 can facilitate wired and/or wireless communications to the network 16 (FIG. 1).

The computing device 126 may be operable to communicate with any wireless devices or entities operatively disposed in wireless communication, for example, a printer, a scanner, or a desktop or portable computer, via wireless technologies, such as Wi-Fi® and Bluetooth®, for example.

Those skilled in the art will recognize improvements and modifications to the preferred embodiments of the present disclosure. All such improvements and modifications are considered within the scope of the concepts disclosed herein and the claims that follow.

What is claimed is:

1. A method performed on a processor for presenting information about a novel, comprising:
displaying a portion of the novel on a display;
receiving, via user input, a selection of a first term at a first location in the novel;
receiving, via user input, a selection of a second term at a second location in the novel, wherein at least one of the first term and the second term identifies a character referenced in the novel;
determining a current location within the novel, wherein the current location is subsequent to a beginning of the novel and prior to an end of the novel;
determining a plurality of relationships between the first term and the second term, wherein the plurality of relationships comprises only those relationships which have been referred to in the novel prior to the current location; and
displaying information describing the plurality of relationships on the display.

2. The method of claim 1, wherein receiving the selection of the first term at the first location in the novel comprises:
receiving, via user input, a selection of a plurality of words in the novel;
identifying a plurality of terms, including the first term, in the plurality of words;
visually distinguishing the plurality of terms from other words in the plurality of words on the display; and
receiving, via user input, the selection of the first term.

3. The method of claim 1, wherein the current location is based on the one of the first location and the second location that is closest to the end of the novel.

4. The method of claim 1, wherein the current location is based on user input identifying a location in the narrative, wherein the location is different from the first location and the second location.

5. The method of claim 1, wherein the current location is based on the portion of the novel that is displayed on the display at a time of selection of the first term.

6. The method of claim 1, wherein determining the plurality of relationships between the first term and the second term further comprises:
accessing a narrative structure comprising narrative entries, each of which identifies a relationship associated with a plurality of terms in the novel and includes a corresponding location identifier identifying where the relationship is referred to in the novel; and
determining a plurality of relationships based on a first plurality of narrative entries associated with the first term and a second plurality of narrative entries associated with the second term.

7. The method of claim 6 further comprising:
filtering the first plurality of narrative entries and the second plurality of narrative entries based on the corresponding location identifiers and the current location.

8. The method of claim 6, wherein determining the plurality of relationships based on the first plurality of narrative entries associated with the first term and the second plurality of narrative entries associated with the second term further comprises:
determining that at least one of the first plurality of narrative entries identifies a relationship between the first term and a third term;
determining that at least one of the second plurality of narrative entries identifies a relationship between the second term and the third term; and
wherein displaying information describing the plurality of relationships on the display further comprises displaying information that identifies that the first term and the second term each has a relationship with the third term.

9. A computing device comprising:
a display; and
a control system comprising a processor and coupled to an input interface, the control system adapted to:
display a portion of a novel on the display;
receive, via user input, a selection of a first term at a first location in the novel;
receive, via user input, a selection of a second term at a second location in the novel, wherein at least one of the first term and the second term identifies a character referenced in the novel;
determine a current location within the novel, wherein the current location is subsequent to a beginning of the novel and prior to an end of the novel;
determine a plurality of relationships between the first term and the second term, wherein the plurality of relationships comprises only those relationships which have been referred to in the novel prior to the current location; and
display information describing the plurality of relationships on the display.

10. The computing device of claim 9, wherein to receive the selection of the first term and the selection of the second term the control system is further adapted to:
receive, via user input, a selection of a plurality of words in the novel;
identify a plurality of terms, including the first term, in the plurality of words;
visually distinguish the plurality of terms from other words in the plurality of words on the display; and
receive, via user input, the selection of the first term.

11. The computing device of claim 9, wherein the current location is based on the one of the first location and the second location that is closest to the end of the novel.

12. The computing device of claim 9, wherein the current location is based on user input identifying a location in the narrative, wherein the location is different from the first location and the second location.

13. The computing device of claim 9, wherein the current location is based on the portion of the novel that is displayed on the display at a time of selection of the first term.

14. The computing device of claim 9, wherein to determine the plurality of relationships between the first term and the second term the control system is further adapted to:
access a narrative structure comprising narrative entries, each of which identifies a relationship associated with a plurality of terms in the novel and includes a corresponding location identifier identifying where the relationship is referred to in the novel; and
determine a plurality of relationships based on a first plurality of narrative entries associated with the first term and a second plurality of narrative entries associated with the second term.

15. The computing device of claim 14, wherein the control system is further adapted to:
filter the first plurality of narrative entries and the second plurality of narrative entries based on the corresponding location identifiers and the current location.

16. The computing device of claim 14, wherein to determine the plurality of relationships based on the first plurality of narrative entries associated with the first term and the second plurality of narrative entries associated with the second term, the control system is further adapted to:
determine that at least one of the first plurality of narrative entries identifies a relationship between the first term and a third term;
determine that at least one of the second plurality of narrative entries identifies a relationship between the second term and the third term; and
wherein to display identifying information about the plurality of relationships on the display the control system is further adapted to display information identifying that each of the first term and the second term has a common relationship with the third term.

17. A computer program product for presenting information about a novel, comprising a non-transitory computer-readable medium having a computer-readable program code embodied therein, the computer-readable program code comprising instructions which, when executed on a processor, cause the processor to perform operations comprising:
displaying a portion of a novel on a display, the narrative comprising a plurality of terms;
receiving, via user input, a selection of a first term at a first location in the novel;
receiving, via user input, a selection of a second term at a second location in the novel, wherein at least one of the first term and the second term identifies a character referenced in the novel;
determining a current location within the novel, wherein the current location is subsequent to a beginning of the novel and prior to an end of the novel;
determining a plurality of relationships between the first term and the second term, wherein the plurality of relationships comprises only those relationships which have been referred to in the novel prior to the current location; and
displaying information about the plurality of relationships on the display.

18. The computer program product of claim 17, wherein determining the plurality of relationships between the first term and the second term further comprises:
accessing a narrative structure comprising narrative entries, each of which identifies a relationship associated with a plurality of terms in the novel and includes a corresponding location identifier identifying where the relationship is referred to in the novel; and
determining a plurality of relationships based on a first plurality of narrative entries associated with the first term and a second plurality of narrative entries associated with the second term.

19. The computer program product of claim 18, wherein the method further comprises:
filtering the first plurality of narrative entries and the second plurality of narrative entries based on the corresponding location identifiers and the current location.

20. The computer program product of claim 18, wherein determining the plurality of relationships based on the first plurality of narrative entries associated with the first term and the second plurality of narrative entries associated with the second term further comprises:
determining that at least one of the first plurality of narrative entries identifies a relationship between the first term and a third term;
determining that at least one of the second plurality of narrative entries identifies a relationship between the second term and the third term; and wherein
displaying information about the plurality of relationships on the display further comprises displaying information that identifies that each of the first term and the second term has a relationship with the third term.
